(19) United States
(12) Patent Application Publication
(10) Pub. No.: US 2015/0183063 A1
(43) Pub. Date: Jul. 2, 2015

(54) METHOD OF JOINING SILVER PASTE

(71) Applicant: Hyundai Motor Company, Seou (KR)

(72) Inventors: Kyoung-Kook Hong, Hwaseong, Gyeonggi-do (KR); Youngkyun Jung, Seoul (KR); Jong Seok Lee, Suwon, Gyeonggi-do (KR); Dae Hwan Chun, Gwangmyeong, Gyeonggi-do (KR); Su Bin Kang, Busan (KR)

(73) Assignee: HYUNDAI MOTOR COMPANY, Seoul (KR)

(21) Appl. No.: 14/469,031

(22) Filed: Aug. 26, 2014

(30) Foreign Application Priority Data
Dec. 30, 2013 (KR) 10-2013-0167817

(51) Int. Cl. B23K 35/30; B23K 35/02; B22F 3/00

(52) U.S. Cl. CPC B23K 35/3006; B22F 3/00; B23K 35/025

(57) ABSTRACT

A method of joining silver paste is provided. The method includes preparing silver paste comprising silver powders and lead powders and heating silver paste. The silver powders are then joined.

### CROSS-REFERENCE TO RELATED APPLICATION

This application claims priority to and the benefit of Korean Patent Application No. 10-2013-0167817 filed in the Korean Intellectual Property Office on Dec. 30, 2013, the entire contents of which are incorporated herein by reference.

### TECHNICAL FIELD

The present invention relates to a method of joining silver paste. More particularly, the present invention provides a method of joining silver paste for joining semiconductor devices.

### BACKGROUND

In accordance with the recent trend of enlargement in size and capacity of application equipment, a demand for semiconductor devices for electric power, having a high breakdown voltage, a high current, and a high-speed switching characteristic has increased. Among the semiconductor devices, a silicon carbide (SiC) semiconductor device may have a merit. For example, since the silicon carbide semiconductor device has a wider band gap than the conventional silicon (Si) semiconductor device, a semiconductor characteristic may be more stably implemented at elevated temperatures.

However, a packaging material may additionally need to be stably applied even at elevated temperatures to obtain a substantially high temperature operation effect. Particularly, since a conventional solder used to join the semiconductor devices has a melting temperature of less than about 230° C., the solder may not be used at a junction temperature of about 250° C. or higher at which the silicon carbide semiconductor device may be applied and operated.

Recently, a high temperature solder including gold (Au) and the like has been proposed as an alternative to replace the conventional solder, but it has been reported that the high temperature solder is more expensive and has a reduced characteristic such as junction strength.

The above information disclosed in this Background section is only for enhancement of understanding of the background of the invention and therefore it may contain information that does not form the prior art that is already known in this country to a person of ordinary skill in the art.

### SUMMARY

The present invention provides a method of joining silver paste without using a glass frit.

In an exemplary embodiment of the present invention, a method of joining silver paste may include: preparing silver paste including a plurality of silver powders and a plurality of lead powders; heating the silver paste; and joining the silver powders. The heating of silver paste may be performed until a heating temperature is higher or equal to about 200° C. In particular, the heating of silver paste may be performed until a heating temperature is elevated to about 400° C.

In an exemplary embodiment, the heating of silver paste may include: converting the lead powder into a liquid phase lead; and surrounding a surface of each silver powder with the liquid phase lead. The joining of the silver powders to each other may include: contacting the liquid phase lead surrounding the surface of each silver powder into contact to the adjacent liquid phase lead; diffusing the liquid phase lead into the silver powder; and diffusing the silver powder into the liquid phase lead to form a junction portion which joins the silver powders to each other. In the joining of the silver powders, the liquid phase lead may be diffused into the silver powder to be removed.

In an exemplary embodiment, a content of the lead powder may be in a range of about 0.1 wt % to about 10 wt %, of about 1 wt % to about 9 wt %, of about 2 wt % to about 8 wt %, of about 3 wt % to about 6 wt %, or particularly of about 4 wt % to about 5 wt % based on the total weight of the silver paste.

According to various exemplary embodiments of the present invention, heating silver paste including silver powders and lead powders may be performed at the melting temperature of lead or higher to join the silver powders.

### BRIEF DESCRIPTION OF THE DRAWINGS

The above and other objects, features and advantages of the present invention will be more clearly understood from the following detailed description taken in conjunction with the accompanying drawing. FIGS. 1 to 6 sequentially illustrate an exemplary method of joining silver paste according to an exemplary embodiment of the present invention.

FIG. 1 illustrates an exemplary state of silver paste which includes silver powders 100 and lead powders 200 according to an exemplary embodiment of the present invention;

FIG. 2 illustrates an exemplary state of silver paste in which the silver paste is heated and lead powders 210 melt into a liquid phase while silver powders 100 maintain in power state according to an exemplary embodiment of the present invention;

FIG. 3 illustrates an exemplary state of silver paste in which the liquid phase lead 210 surrounds each single silver powder 200 according to an exemplary embodiment of the present invention;

FIG. 4 illustrates an exemplary state of silver paste in which the liquid phase lead 210 surrounding the silver powder makes contact with adjacent liquid phase lead 210 surrounding other silver powder according to an exemplary embodiment of the present invention;

FIG. 5 illustrates an exemplary state of silver paste in which a junction portion 110 is formed between silver powders 100 surrounded by the liquid phase lead 210 according to an exemplary embodiment of the present invention; and

FIG. 6 illustrates an exemplary state of silver paste in which silver powders 100 are joined through the junction portion while the liquid phase lead is diffused in the silver powders according to an exemplary embodiment of the present invention.

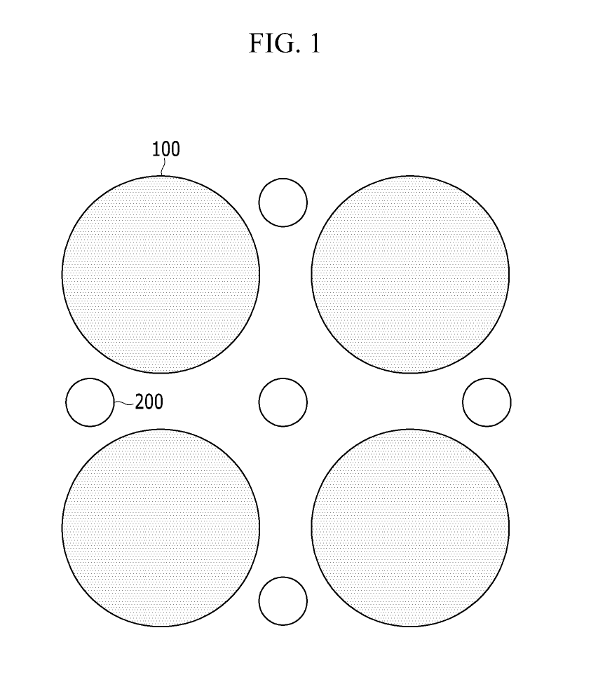

Reference numerals set forth in the FIGS. 1-6 include reference to the following elements as further discussed below:

100: Silver powder

110: Junction portion

200: Lead powder

210: Liquid phase lead

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, exemplary embodiments of the present invention will be described in detail with reference to the accompanying drawings. As those skilled in the art would realize, the described embodiments may be modified in various different ways, all without departing from the spirit or scope of the present invention. On the contrary, exemplary embodiments introduced herein are provided to make disclosed contents thorough and complete and sufficiently transfer the spirit of the present invention to those skilled in the art.

In the drawings, the thickness of layers, films, panels, regions, etc., are exaggerated for clarity. It will be understood that when a layer is referred to as being “on” another layer or substrate, it can be directly on the other layer or substrate, or intervening them may also be present. Like reference numerals designate like elements throughout the specification. p According to an exemplary embodiment of the present invention, silicon carbide (SiC) semiconductor devices may be joined using silver paste that includes silver powders 100 and lead powders 200. When the semiconductor devices are joined, silver paste may be formed on the semiconductor device of a junction target, and the semiconductor devices may be joined by joining silver paste and silver paste. In other words, when silver paste and silver paste are joined, the silicon carbide semiconductor devices may be joined.

Hereinafter, a method of joining silver paste will be described in various exemplary embodiments.

FIGS. 1 to 6 sequentially illustrate the exemplary method of joining silver paste according to an exemplary embodiment of the present invention. In FIG. 1, silver paste including a plurality of silver powders 100 and a plurality of lead powders 200 may be prepared. In an exemplary embodiment, a silver powder or a lead powder may be in a form of a particle. In particular, the content of lead powder 200 contained in the silver powder may be in a range of about 0.1 wt % to about 10 wt %, of about 1 wt % to about 9 wt %, of about 2 wt % to about 8 wt %, of about 3 wt % to about 6 wt %, or particularly of about 4 wt % to about 5 wt % based on the total weight of the silver paste, without limitation. However, the content of the lead powder may not be limited thereto. In addition, a diameter of the silver powder 100 or the lead powder 200 may be in a range of about 1 μm to about 10 μm.

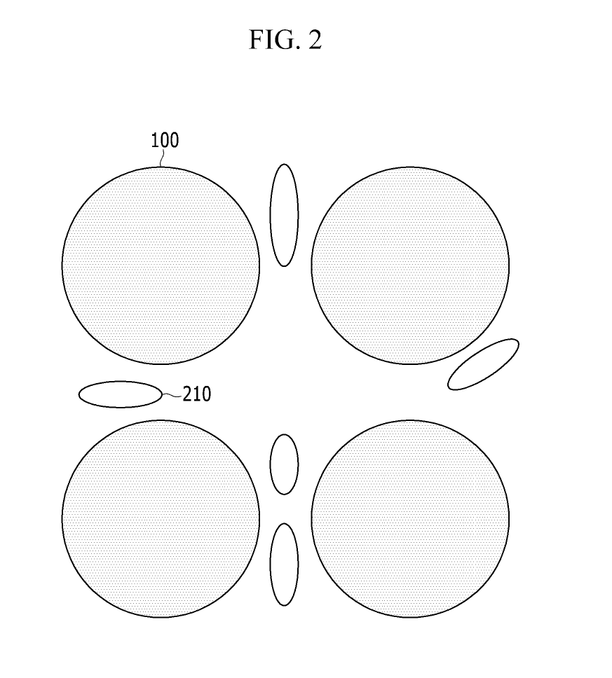

In FIG. 2, the silver paste including silver powders 100 and lead powders 210 may be heated. Heating may be performed until a heating temperature is higher or equal to about 200° C. In particular, the heating temperature may be elevated to about 400° C. When the heating temperature reaches a melting temperature of lead, which may be about 327° C., the lead powder 200 in FIG. 1 melts and is converted into a liquid phase lead 210. Since a melting temperature of silver is about 962° C., the powder state of the silver powder 100 may be maintained at the temperature of about 400° C. In this state, a chemical reaction may not occur between the liquid phase lead 210 and the silver powder 100 in the powder state.

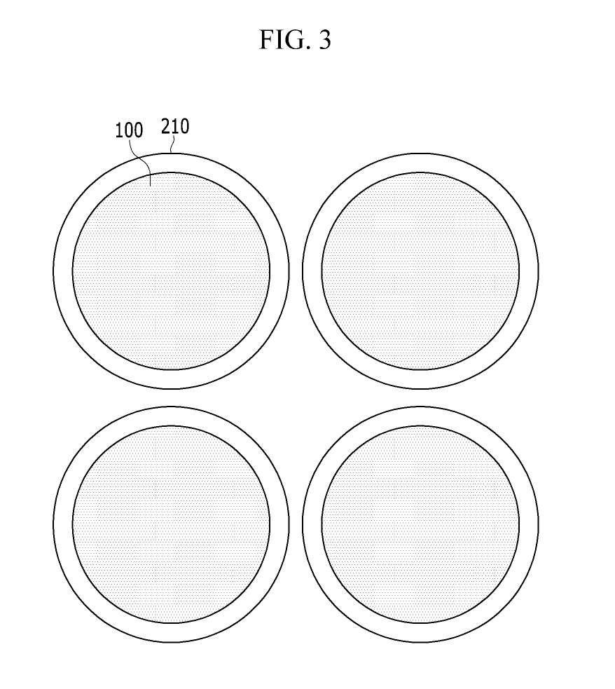

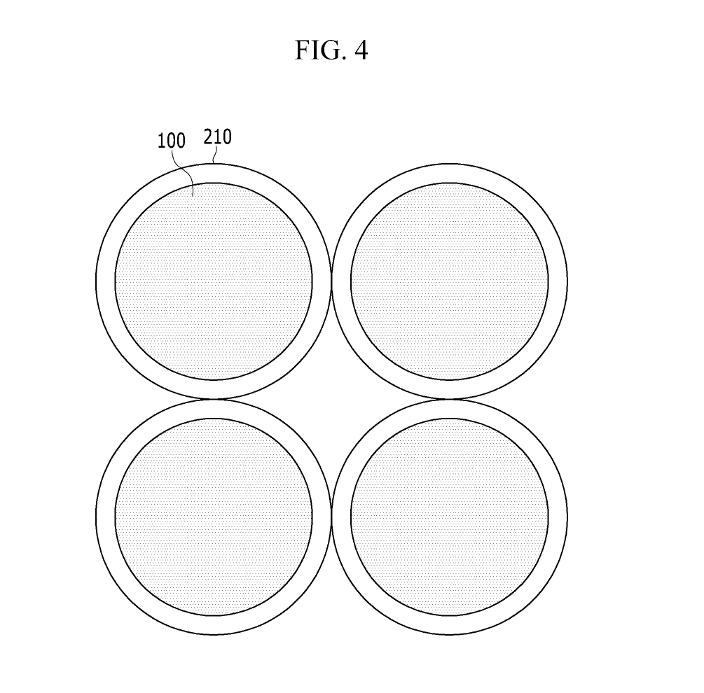

In FIGS. 3 and 4, the liquid phase lead 210 may be in a wetting state on a surface of each silver powder 100 and capable of surrounding the surface of each single silver powder 100. A term “wetting state” as used herein may refer to a state in which a gas which contacts a solid surface may be expelled by a liquid phase and thus a solid-gas interface may be converted into a solid-liquid interface.

Subsequently, as shown in FIG. 4, the liquid phase lead 210 surrounding the surface of the silver powder 100 may approach each other and be in direct contact with the adjacent liquid phase lead 210 surrounding other silver power, and thus the liquid phase leads 210 surrounding the silver powder 100 may be in direct contact with each other.

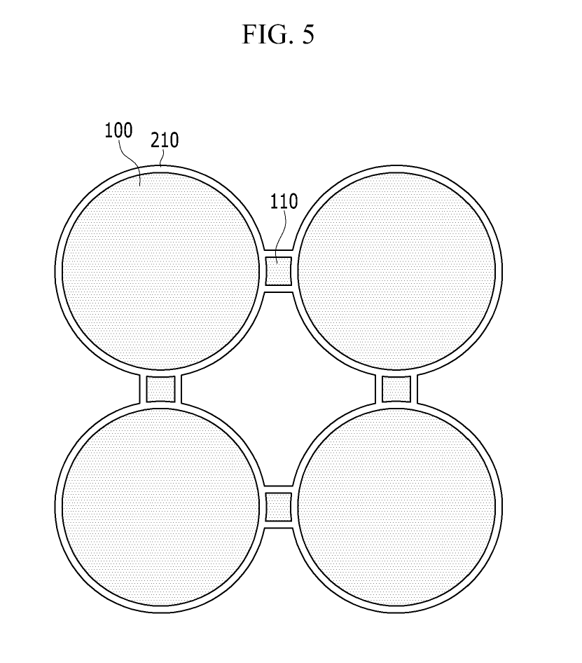

In FIG. 5, the liquid phase lead 210 surrounding the silver powder 100 may be gradually diffused into the silver powder 100 through contact between the liquid phase lead 210 and the liquid phase lead 210, thereby reducing an amount or a thickness of the liquid phase lead 210 surrounding the silver powder 100. Further, the silver powder 100 may diffused into the liquid phase leads 210 in contact with each other, thereby forming a junction portion 110 which may join the silver powders 100.

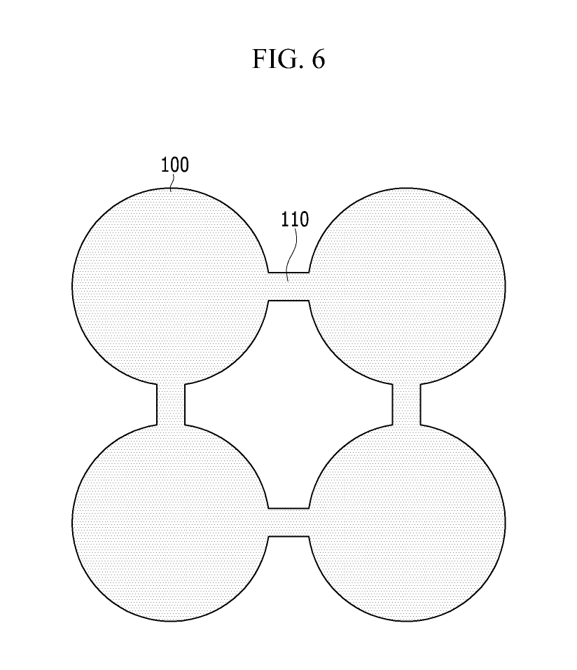

In FIG. 6, the liquid phase lead 210 surrounding the silver powder 100 may be completely diffused into the silver powder 100 and thus removed. Accordingly, the silver powders 100 in the silver paste may be joined at least one or more other silver powders through the junction portion 110. Accordingly, the silver paste may be joined and the semiconductor devices on which silver paste is formed may be joined due to junction of silver paste.

According to an exemplary embodiment, the method of joining the silver powder 100 and the silver powder 100 may be a transient liquid phase diffusion bonding. As used herein, the term “transient liquid phase diffusion bonding” may refer to a method to join substantially identical metal component A, which may comprising: positioning a metal B having a melting temperature lower than a melting temperature of the metal A between the metals A; performing heating of a mixture of metals A and B to the melting temperature of the metal B or higher but less than the melting temperature of the metal A; and diffusing the metal B which may be in a liquid phase into the solid phase metal A. Thereafter, the metal B may be removed and the solid phase metals A may be joined to each other.

In an exemplary embodiment of the present invention, lead, of which the melting temperature is less than that of silver, may be used to join silver and silver. Since the melting point of silver is sufficiently higher than that of lead, the silver powder 100 may be a material for junction, and the lead powder 200 may be an activation material for joining the silver powders 100. As described above, when silver paste is joined, the silver powder 100 may be diffused into the liquid phase lead 210 while the liquid phase lead 210 may be diffused into the silver powder 100, and therefore, a junction time may be shortened.

In related arts, the conventional junction of silver paste may be performed by sintering, and sintering may rely on a temperature, and further a sintering time may reply on a size of the silver powder. According to various exemplary embodiment of the present invention , since the silver powders may be joined by heating the silver powders at the melting temperature of lead or higher without melting or affecting the silver powders, the silver powders having substantially large particles may be used.

In addition, since the conventional silver paste may include a sintering medium material such as a glass frit and such sintering medium material is not metal, electric resistance thereof may increase. However, according to various exemplary embodiment of the present invention, the sintering medium material may not be used and metallic lead may be used as activation material for joining the silver powders, and therefore, electric resistance may be reduced.

While this invention has been described in connection with what is presently considered to be exemplary embodiments, it is to be understood that the invention is not limited to the exemplary embodiments, and is intended to cover various modifications and equivalent arrangements included within the spirit and scope of the appended claims.

What is claimed is:

1. A method of joining silver paste, comprising:
preparing silver paste that includes a plurality of silver powders and a plurality of lead powders; heating the silver paste; and
joining the silver powders.

2. The method of claim 1, wherein the heating of the silver paste is performed until a heating temperature is elevated to about 400° C.

3. The method of claim 1, wherein the heating of the silver paste includes:
converting the lead powder into a liquid phase lead; and
surrounding a surface of each silver powder with the liquid phase lead.

4. The method of claim 3, wherein the joining of the silver powders includes:
contacting the liquid phase lead surrounding the surface of each silver powder to the adjacent liquid phase lead;
diffusing the liquid phase lead into the silver powder; and
diffusing the silver powder into the liquid phase lead to form a junction portion which joins the silver powders.

5. The method of claim 1, wherein in the joining of the silver powders, the liquid phase lead is diffused into the silver powder to be removed.

6. The method of claim 1, wherein a content of the lead powder is in a range of about 4 wt % to about 5 wt % based on the total weight of the silver paste.
